(19) United States
(12) Patent Application Publication
(10) Pub. No.: US 2005/0047442 A1
(43) Pub. Date: Mar. 3, 2005

(54) Method and apparatus for collectively and selectively analyzing the signal integrity of individual cable modems on a DOCSIS network

(76) Inventors: Brady Volpe, Columbia, MD (US); Kevin Newgent, Columbia, MD (US)

Correspondence Address: ROSSI & ASSOCIATES, P.O. Box 826, Ashburn, VA, 20146-0826, US

(21) Appl. No.: 10/647,899

(22) Filed: Aug. 25, 2003

(51) Int. Cl. H04L 1/00

(52) U.S. Cl. 370/480

(57) ABSTRACT

A method and apparatus is provided for quantifying the upstream communication signals transmitted by remotely deployed CMs, and particularly cable modems operated consistent with the DOCSIS specification. Specifically, the method and apparatus provides the capability to capture, demodulate, and analyze the digital transmission originating from a CM source of known or unknown origin, and determine the unique MAC address or SID of the source CM that is measured. Additionally, the method and apparatus has the ability to analyze in the presence of many CMs, a specific user defined or user defined range of CMs by the implementation of real-time filtering either by method of pre-determination of the arrival time of the CM signal or by real-time filtering and analysis of the captured CM signal.

### FIELD OF THE INVENTION

The present invention relates in general to a method and apparatus for capturing, demodulating, and filtering the upstream communication signals from Cable Modems (CMs) in DOCSIS and Euro-DOCSIS-based communication networks. More specifically, the present invention relates to a method and apparatus for determining the signal integrity of the CM signal as a function of Error Vector Magnitude (EVM) and Modulation Error Ratio (MER) of the demodulated I-Q data contained in the signal.

### BACKGROUND OF THE INVENTION

Broadband, hybrid fiber-coaxial (HFC)-based communication networks include many miles of fiber optic and coaxial cables distributed throughout a service area. The network of cables is inter-dispersed with active and passive elements for the purpose of distributing the signals in a bi-directional fashion. The network of cables forms the physical (PHY) transport mechanism over which radio frequency (RF) signals may be distributed for the purpose of transmitting and receiving data, including analog and digital formats via Frequency Division Multiplexing (FDM) and Time Division Multiplexing (TDM).

One popular communication standard for data transport that is implemented on an HFC network is the Data Over Cable Service Interface Specification (DOCSIS). Three revisions currently exist for a North American DOCSIS standard, namely, DOCSIS 1.0, 1.1, and 2.0. In addition to the 6-MHz wide North American based DOCSIS standard, there exists a European (Euro-DOCSIS) standard formatted for 8-MHz wide bandwidth channels. The DOCSIS standard utilizes two primary elements for the transmission of data over the HFC network. The first element is the Cable Modem Termination System (CMTS), which is located in specified nodes on the HFC network that serve as the source of data to be distributed to end-of-line subscribers. The second element of the DOCSIS network is the Cable Modem (CM), which resides at or in the subscriber's location.

The CMTS is responsible for regulating the proper operation of all remotely distributed CMs, which are physically connected to the CMTS via the HFC network. The CMTS communicates with the CMs in accordance with the provisions of the DOCSIS specification. Data is transmitted to the CMs from the CMTS by modulating digital data into either 64- or 256-QAM, and then up-converting the modulation to the appropriate “downstream” frequency, which is then transmitted to the CMs over the HFC network. The modulated carrier is formatted in a continuous MPEG data stream, which may or may not contain other un-related MPEG formatted information.

The CMs communicate with the CMTS device according to the DOCSIS specification by modulating digital data into QPSK, 8-, 16-, 32-, 64-, or 128-QAM, and then up-converting the modulated signal to the appropriate “upstream” frequency, which is then transmitted to the CMTS over the HFC network. Since many CMs may be distributed in a network, the CM's transmit data in a TDM format. Time slots for each CM are allocated by the CMTS and communicated to the each CM via the downstream channel.

Subscribers may access available network resources over the DOCSIS network by using the data communication bridge established by the DOCSIS and HFC network. Subscribers send data from their digital device (PC, VoIP phone, Video IP device, etc) into the CM, which then relays the data to the CMTS. The CMTS in turn then relays the information to the appropriate network element. Information destined to the subscriber digital device is provided from the network to the CMTS, which in turn relays the information to the CM. The CM in turn relays the information to the subscriber's digital device.

All system maintenance, operation and network communications are outlined in the DOCSIS specification. DOCSIS 1.0 and 1.1 allow for upstream communications in QPSK or 16-QAM in TDMA. DOCSIS 2.0 adds additional upstream formats covered under the A-TDMA and S-CDMA sections of the standard.

Many vendors currently provide test equipment for analyzing the downstream MPEG channel transmitted by the CMTS. The test equipment demodulates the downstream channel and performs EVM and MER analysis of the digital data to quantify the quality of the transmitted signal throughout the HFC network. Conventional test equipment, however, is not capable of performing EVM and MER analysis on the upstream data transmitted by the CMs. Providing upstream analysis capability is not a trivial exercise due to the complex nature of capturing a signal on a TDMA-based network. CMs broadcast short bursts of information during their assigned time frame and then discontinue transmitting information so that other CMs on the network have an opportunity to transmit their respective information. The instant-on, instant-off nature of the upstream communications makes signal analysis with conventional test equipment extremely difficult if not impossible. The exercise is further complicated by the fact that the test device must also be capable of determining the source (a specific CM) of the signal in order for the user to find useful information in the analysis of the signal. That is, if the user does not know which CM has a poor signal, knowing that a poor signal exists in the network is of little use.

In view of the above, it would be desirable to provide a method and apparatus for performing EVM and MER analysis on the upstream data transmitted by the CMs.

### SUMMARY OF THE INVENTION

A method and apparatus is provided for quantifying the upstream communication signals transmitted by remotely deployed CMs, and particularly cable modems operated consistent with the DOCSIS specification. Specifically, the method and apparatus provides the capability to capture, demodulate, and analyze the digital transmission originating from a CM source of known or unknown origin, and determine the unique MAC address or SID of the source CM that is measured. Additionally, the method and apparatus has the ability to analyze in the presence of many CMs, a specific user defined or user defined range of CMs by the implementation of real-time filtering either by method of pre-determination of the arrival time of the CM signal or by real-time filtering and analysis of the captured CM signal.

In one preferred embodiment, the present invention is designed specifically for end-of-line testing in close proximity to a CMTS device whereby the upstream and downstream modulated carriers are located on separate cables. Independent upstream and downstream inputs are provided to tap into and monitor the signals on the independent cables.

In another preferred embodiment, the present invention is designed for testing at a location between the CMTS device and CM or at the CM location itself, whereby the upstream and downstream communication channels are combined on the same coaxial cable. A common input is provided which separates the upstream and downstream signals and directs them to their respective demodulators.

DOCSIS-based signals located on the downstream channel are down converted and demodulated to their base band digital equivalent signals. This digital information is passed along to a Media Access Controller (MAC) processor, which converts the raw digital data into meaningful DOCSIS protocol and payload information which is then further processed by a personal computer (PC).

DOCSIS-based signals located on the upstream channel are down converted and demodulated to their base band digital equivalent signals. This digital information is passed along to the MAC processor, which converts the raw digital data into meaningful DOCSIS protocol and payload information which is then further processed by the PC.

Using standard algorithms for EVM and MER calculations, the raw upstream digital data is analyzed for each CM signal burst, enabling an EVM and MER calculation to be made and displayed in a numerical and graphical format on the PC display.

A database of all CMs on the respective channel is built as the CM bursts are captured. EVM and MER values for the respective CMs are collected and integrated with the database. Sorting options are provided to the user for determining which CMs have acceptable performance and which CMs have poor performance as defined by the user based upon the available EVM and MER data.

A alternatively, the user may select a specific CM MAC address or range (mask) of CM MAC addresses to monitor. This provides a utility for the user to analyze a specific CM or range of CMs which may be experiencing communication difficulties.

Finally, analysis of all CMs on a particular branch of the HFC network may be observed. The respective EVM and MER data for all CMs is collected and presented in a numerical and graphical format for the user. This provides a utility for the user to make qualitative analysis of the specific branch. This analysis may provide data regarding the signal transport quality of the physical branch in addition to a deterministic analysis as to whether the specific branch can support a higher order modulation format than that which is currently employed.

Other advantanges and features of the invention will become apparent to those skilled in the art upon review of the following detailed description of the preferred embodiments of the invention and the accompanying drawings.

### BRIEF DESCRIPTION OF THE DRAWINGS

The invention will be described in greater detail with reference to the following detailed description of the preferred embodiments of the invention and the accompanying drawings, wherein

FIG. 1 is a schematic block diagram illustrating a conventional HFC distribution network over which DOCSIS communications may be established;

FIG. 2 is a schematic block diagram illustrating an architecture whereby a signal integrity analyzer, in accordance with the present invention, is configured as a test instrument locally to a CMTS device in a network illustrated in FIG. 1;

FIG. 3 is a schematic block diagram illustrating an architecture whereby a signal integrity analyzer, in accordance with the present invention, is configured remotely from a CMTS device in a network illustrated in FIG. 1 on either an HFC branch (node) or at a subscriber location;

FIG. 4 is a schematic block diagram of functional elements embodied in the signal integrity analyzer illustrated in FIGS. 2 and 3; and

FIG. 5 illustrates the display of data in both numerical and graphical form based on the anaysis performed by the signal integrity analyzer illustrated in FIGS. 2-4.

### DETAILED DESCRIPTION OF THE PREFERRED EMBODIMENTS OF THE INVENTION

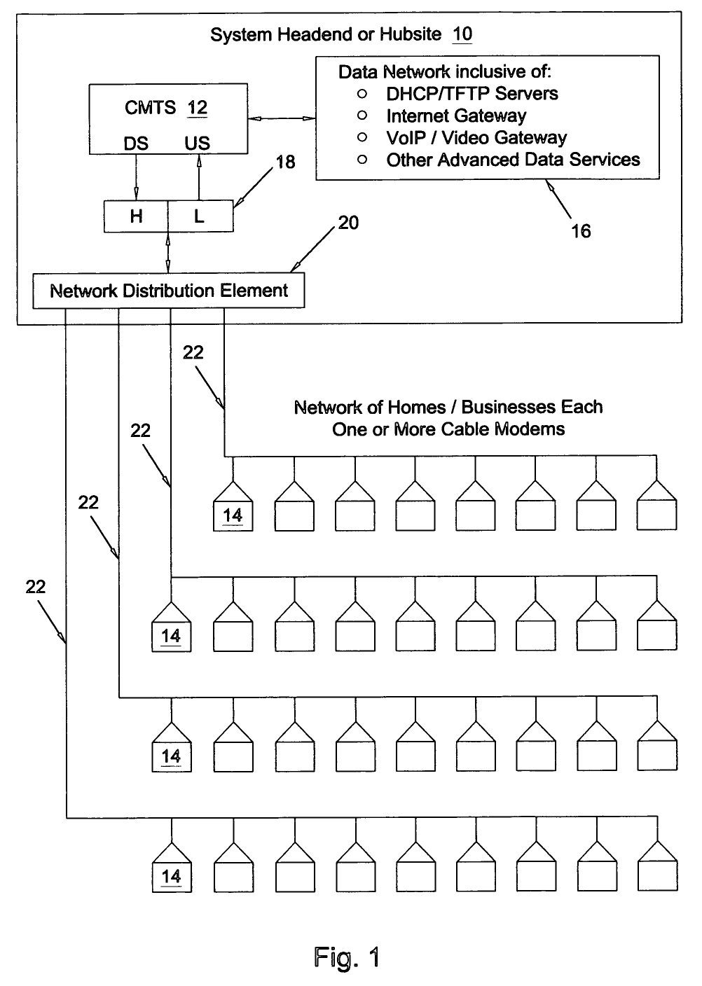

FIG. 1 illustrates a generalized schematic block diagram representation of a conventional HFC network over which various consumer services may be provided, inclusive of DOCSIS. A system headend or hubsite 10 is provided that houses electronic communication equipment in an environmentally controlled building or structure. A CMTS 12 is located within the system headend 10. The CMTS 12 establishes communication over an RF HFC network to a plurality of CMs 14 (functioning on the DOCSIS standard) located at individual subscriber locations. Two-way data communications is provided between the system headend 10 and the CM's 14.

Specifically, the CMTS device 12 is linked to the network backbone via a data network 16. The data network 16 includes the conventional servers and gateways necessary to system operation and network throughput. A passive device or series of passive and active devices, for example a diplex filter 18, combines the downstream (DS) and upstream (US) communication paths from and to the CMTS device 12 on a single coaxial cable (FDM), so that it may be distributed over the HFC network. Similarly, a network distribution element 20, including a number of passive and active devices, is provided that transmits, receives and effectively distributes communications data over the HFC network. Various distribution legs or nodes 22 may be present in an HFC network, wherein each node 22 serves a different geographic area. In the illustrated example, four different nodes 22 are provided.

One CMTS 12 can serve many CMs 14 spread out over a wide coverage area. In fact, in theory, one CMTS device 12 can support over 8000 CMs 14. Practical applications, however, suggest that each CMTS device 12 should only support several hundred CMs 14 in order to provide a high quality of service to the subscriber.

The CMTS 12 in FIG. 1 communicates maintenance information and relays subscriber-bound payload (data) on a downstream RF modulated carrier in the 88-870 MHz RF frequency spectrum. The modulation format is either 64- or 256-QAM as determined by the service provider. Payload destined for a specific CM 14 is transmitted to all CMs 14. It is the responsibility of each CM 14 to determine which data is destined for that specific CM 14.

The CMs 14 in FIG. 1 communicate maintenance information and relay network-bound payload (data) on an upstream RF modulated carrier in the 5-42 MHz (domestic), 5-55 MHz (Asia), and 5-65 MHz (Europe) RF frequency spectrum, referred to as the upstream. The modulation format is either QPSK or 16-QAM for DOCSIS 1.0 and 1.1, with other QAM modulated formats added in DOCSIS 2.0.

The upstream system operates in a Time-Division-Multiplexed (TDM) mode. The CMTS device 12 provides time slots for each CM 14 to communicate on the upstream channel and provides this timing information to each CM 14 via maintenance information called “MAP” messages. The CM 14 waits for its specific time interval, then begins transmitting a burst of payload to the CMTS device 12. Once the CM 14 has transmitted its respective payload, it discontinues transmitting and sits in a “listen-mode” until its next time slot. All CMs 14 function in this manner as defined by the DOCSIS specification. Due to the burst nature of the CMs 14, analysis of the CM traffic is difficult with conventional test equipment. Spectrum analyzers may be used by capturing the sum of all CMs 14 transmitting, whereby the user can estimate an overall system Signal-to-Noise (SNR) level, however it is impossible to analyze the quality of signal of any specific CM.

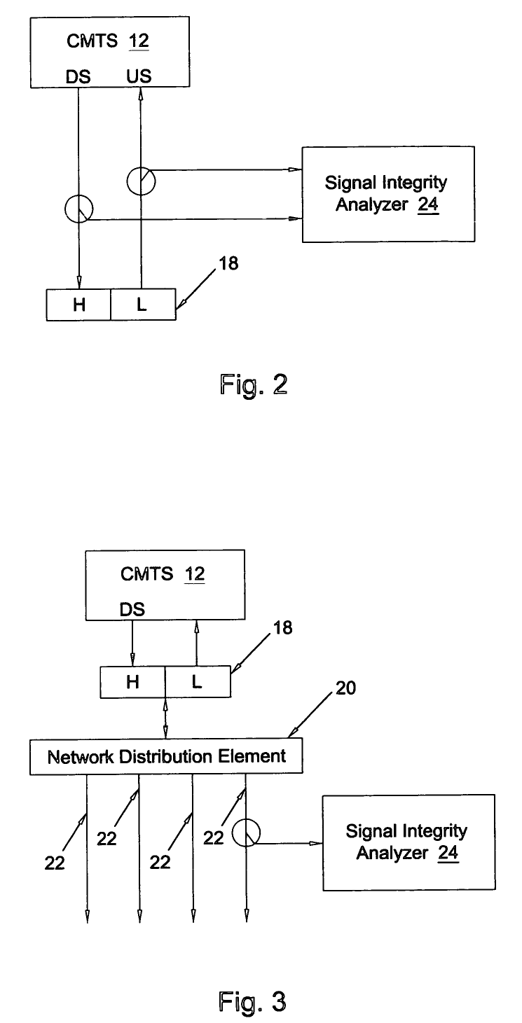

FIG. 2 illustrates the connection of a signal integrity analyzer 24 in accordance with the invention to the conventional HFC network of the type illustrated in FIG. 1, thereby enabling complete signal analysis of individual CMs 14 as well as the entire system. As in the conventional network, the CMTS 12, communicates to the CMs 14 on the downstream channel. The CMs 14 communicate with the CMTS 12 via the upstream channel. The diplex filter 18 enables the combination of both downstream and upstream channels onto the same cable for network distribution as previously described. The signal integrity analyzer 24 is connected into the system by using direction couplers 26. One directional coupler 26 is connected into the downstream channel and provides a monitoring port for downstream communications to the signal integrity analyzer 24. A second direction coupler 26 is connected into the upstream channel and provides a monitoring port for the upstream communications to the signal integrity analyzer 24. The illustrated architecture enables the signal integrity analyzer 24 to monitor both the downstream and upstream communications channels of all devices connected to the CMTS 12.

FIG. 3 illustrates an alternative architecture for connecting the signal integrity analyzer 24 to the HFC network in order to perform the signal analysis of a localized port. This alternative architecture provides a subset of information to the user that enables the user to analyze specific areas of the physical network without the added signals from other nodes in the network. As in FIG. 1, the CMTS device 12 connects to the diplex filter 18, which in is coupled to the network distribution element 20. A directional coupler 26 is used to couple the combined downstream/upstream communication signal to the signal integrity analyzer 24. Since both downstream and upstream communication signals are co-located on the same cable via FDM, only one coupler 26 is required as compared with the architecture illustrated in FIG. 2. In the illustrated embodiment, four possible nodes 22 are shown, wherein each node 22 may be individually monitored by coupling the signal integrity analyzer 24 to a specific node 22.

Although FIGS. 2 and 3 illustrate two preferred implementations of coupling the signal integrity analyzer 24 to the network, it will be understood by those skilled in the art that additional configurations are possible. For example, the signal integrity analyzer 24 may be located elsewhere in the network further away from the network distribution element 20. In such a case, the signal integrity analyzer 24 could be used to isolate communication impairments in the network anywhere between the CMTS device 12 and subscriber locations.

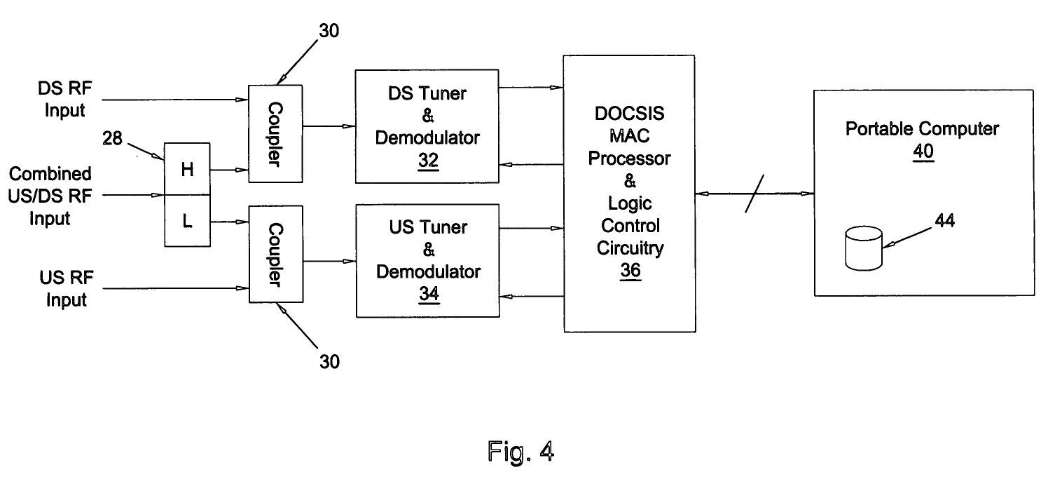

FIG. 4 illustrates a preferred implementation of the signal integrity analyzer 24 in accordance with the present invention. In the illustrated embodiment, three input ports are provided: a downstream (DS) RF input port; an upstream (US) RF input port; and a combined DS/US RF input port. The input ports are coupled to a diplex filter 28 and couplers 30 as shown which enables the signal integrity analayzer 24 to be easily configured for use in both architectures illustrated in FIGS. 2 and 3. The couplers 30 are utilized for directly coupling the downstream and upstream signals into the signal integrity analyzer 24 in the configuration illustrated in FIG. 2. When the architecture of FIG. 3 is implemented, the combined US/DS RF signal is supplied to the diplex filter 28. The diplex filter 28 then separate the downstream and upstream FDM signals and directs them to their respective paths through the couplers 30. The downstream and upstream outputs of the couplers 30 are provided to respective DS and US tuner & demodulators 32, 34.

The DS tuner & demodulator 32 performs the operations of tuning, down-converting, and demodulating the downstream DOCSIS channel as specified by the operator. Conventional off-the-shelf components, which have been developed for the CM side operation, can be utilized for the DC tuner & demodulator 32. The DC tuner & demodulator 32 is controlled by a DOCSIS MAC processor 36, and provides basedband, raw I-Q data from the demodulated downstream channel to the DOCSIS MAC processor 36 for further processing.

Similarly, the US tuner & demodulator 34 includes an RF tuner, which up converts the desired upstream communication channel to a high-performance SAW filter for adjacent channel rejection, then down converts the filtered signal to an IF which is input to a demodulator. The demodulator digitizes the signal with conventional analog-to-digital converters. The digitized signal is then processed with burst-demodulator algorithms resident in a Field Programmable Gate Array (FPGA). The demodulation algorithms demodulate either QPSK or QAM modulated signals and pass the raw I-Q data to a DOCSIS MAC processor 36 for further processing.

The DOCSIS MAC processor 36 provides command and control information to DS and US tuner & demodulators 32, 34, and includes two FPGAs (not shown). One FPGA processes the raw I-Q downstream data from the DS tuner & demodulator 32, and formats the data into DOCSIS equivalent protocol packets. The second FPGA processes the raw I-Q upstream data from the US tuner & demodulator 34, and formats the data into DOCSIS equivalent protocol packets. Additional circuitry is implemented via CPLDs, which provide command and control information to the DS and US tuner & demodulators 34,36. The command and control information controls frequency tuning, gain adjustments, and filter control information to the demodulators for rejecting or accepting specific types of data, using conventional circuitry. Also resident on the DOCSIS MAC processor 36 are two FIFOs and a PCI controller interface chip, which buffers and transfer final data from the DOCSIS MAC processor 36 over a PCI bus 38 to a PC 40.

The PC 40 provides several functions. It serves as the platform for configuration and download of all firmware associated with the PCI based programmable components. The PC 40 serves as the user interface for data entry and data display. In addition, the PC's hard drive may serve as the medium for storing database and historical information associated with the collected CM relational and signal EVM/MER information for time-based analysis.

The signal integrity analyzer 24 illustrated in FIG. 4 may be utilized in a variety of ways to monitor CM performance. Three preferred methods of utilizing the signal integrity analyzer will be discussed in greater detail, however, additional methods of utilization are possible.

In a first preferred method, the downstream communication channel is analyzed in order to know with prior knowledge the time locations of arrival of specifically identified CMs on the node directly connected to the US RF Input. Using the DOCSIS MAC processor 36, the PC 40 captures and builds a database of CM MAC addresses and corresponding Service flow IDentifiers (SIDs), as assigned by the CMTS device 12. By analyzing range-response messages from the CMTS to the CM (a maintenance function provisioned under the DOCSIS protocol), the PC 40 is able to build a MAC/SID relational database 44 that extracts CM MAC address information and all SIDs associated with that specific MAC address.

When the user enters a specific MAC address to analyze, the PC utilizes the DOCSIS MAC processor 36 to analyze downstream MAP information from the CMTS device 12 to the CM 14, which communicates to the CM 14 the time slot it shall broadcast for the particular SID assigned to the CM MAC address. The MAP messages do not contain the CM MAC address, but only the SID. This is the reason that a database of relational MAC addresses with SIDs must be developed. By utilizing the relationional database, data from individual CMs 14 can be identitifed and analyzed.

In a second preferred method, the downstream communication channel need not be analyzed. Filter information is directly communicated to the upstream DOCSIS MAC processor 36. The filter information is provided by the user in terms of a specific MAC address or known SID as determined by the specific application/user. The MAC address and/or SID is then loaded into the DOCSIS MAC processor 36 by the PC 40 over the PCI bus 38. The DOCSIS MAC processor 36 then analyzes the DOCSIS protocol header information of each incident packet. Packets which match the MAC/SID filter profile are collected and analyzed for EVM/MER performance. For example, the packets are downloaded to the PC 40 for storage and analysis. Packets which do not match the MAC/SID filter are rejected.

Variations are also possible when no specific MAC/SID address is being filtered. For example, random upstream bursts may be collected in real-time by the US tuner & demodulator 32. Some of these bursts will contain MAC addresses while some of the bursts will contain only the corresponding SID address. The MAC/SID relational database 44 provides a method by which the I-Q data from a specific burst can be looked up in reverse after EVM/MER analysis is performed on the I-Q data such that EVM/MER can be correlated to known MAC addresses. Further, the MAC/SID information of each captured packet may be displayed along with its corresponding EVM/MER analysis and saved to file. This information can then be analyzed by the user to accomplish the task at hand.

The above-described methods provide a functional analysis tool which is needed depending upon the specific type of analysis to be performed. The first method is the preferred method after a CM 14 has properly registered with the CMTS device 12 and has been assigned a permanent SID or SIDs. In this case, the user has the ability to analyze every incident burst from a specific MAC address regardless of whether or not the burst contains the MAC address of the source CM 14. Under the DOCSIS protocol, a CM 14 can communicate data either by using its source MAC address or by its assigned SID. The first method, however, requires that the downstream channel be available to the signal integrity analyzer 24. The second method is the preferred method prior to a CM 14 being assigned a permanent SID (during the registration process). At this time, no SID or a temporary (unknown) SID may be assigned to the CM 14, which may be unknown to the present invention. Utilizing the second method assures that bursts filtered using the MAC/SID filter will match the desired MAC/SID addresses. The second method is also the preferred method in the absence of an available downstream channel or in the presence of a CM 14 which is broadcasting in a state that is not registered with the CMTS device 12, thus violating the DOCSIS protocol (rogue modem).

Determination of EVM and MER are consistent with standard mathematical methods of calculating EVM and MER using the available raw I-Q data from the upstream US tuner & demodulator 34 with known center-sample points, also provided by the Us tuner & upstream demodulator 34. For reference, the mathematical formulas for EVM and MER are provided as follows:
EVM Calculation: Error Vector Magnitude is not frequently used as a value of analysis in the industry to which the present invention is used; however it is presented as a point of reference to which MER is calculated. EVM is determined by analysis of the raw I-Q data with known center sample point as provided by the upstream demodulator as compared to the ideal I-Q constellation locations as follows:
   EVM=\sqrt{(I−I_{ideal})²+(Q−Q_{ideal})²}
MER Calculation: Modulation Error Ratio (MER) is a measure of the constellation cluster variance due to any impairment measured relative to the ideal constellation point locations. This is generalized by the following equation:

$$MER ( dB ) = 10 log ( \frac{RMS error magnitude}{average symbol magnitude} )$$

And mathematically expressed by:

$$MER ( dB ) = - 10 \cdot log \{ \frac{{\sum }_{j = 1}^{N} ( {( {l}_{j} - {Io}_{j} )}^{2} + {( {Q}_{j} - {Qo}_{j} )}^{2} )}{{\sum }_{j = 1}^{N} ( {Io}_{j}^{2} + {Qo}_{j}^{2} )} \} dB$$

where I and Q are the measured components of the modulation vector as provided from the upstream demodulator, Iₒ and Qₒ are the ideal components of the QAM constellation data point closest to the measured I, Q point in a mean square error sense, and N is the number of points that were captured in the data burst from the upstream demodulator. An aggregate MER is displayed by capturing multiple CM bursts and quantified as:

$${MER}_{T} = - 10 \cdot log \{ \frac{1}{NN} {\sum }_{i = 1}^{NN} {10}^{{MER}_{i} / 10} \} dB$$

where NN is the number of measurements made, and the index, i, ranges over those measurements, and MER_{T} is the aggregate MER of the measurements. Note that this assumes that the total signal energy in each measurement is identical, whereby each captured burst is normalized by software algorithm to fulfill this assumption.

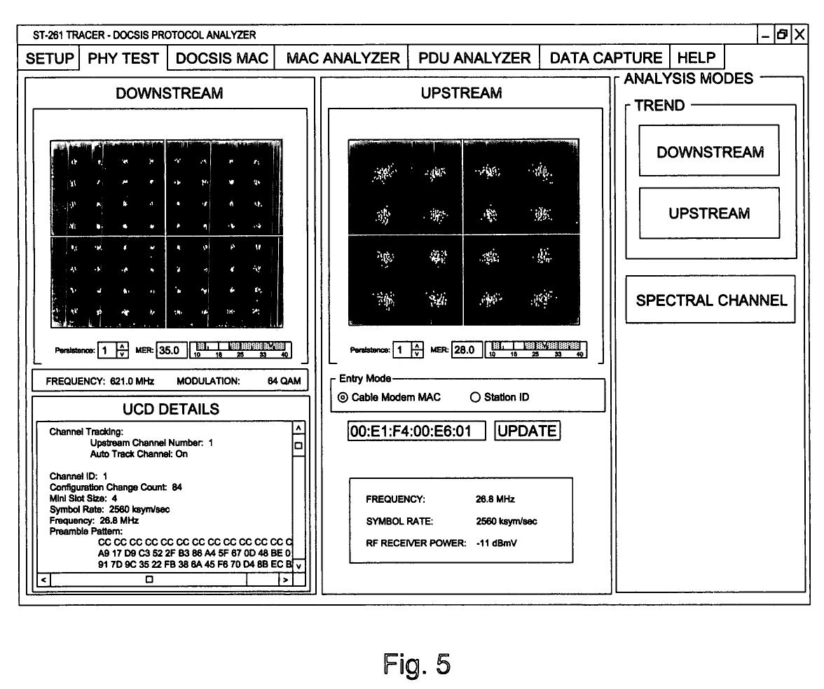

The PC 40 is preferably utilized to display data both numerically and graphically along with the respective constellation diagram as provided by the captured raw I-Q data from the upstream demodulator. FIG. 5 illustrates an example of both numerical and graphical display of data. Modes of operation accessible from a drop-down menu may include as follows:
Average MER: A running average of all received US bursts independent of the source. This will use MERT for computation. NN shall be set by the user with a definable parameter indicated by 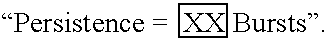
Specific MER: A running average of all US bursts from a specific MAC address or SID. The respective MAC address or SID is user definable in an available MAC address or SID with a drop down menu.

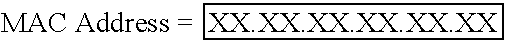

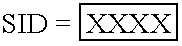

Additionally, a subset of CMs can be analyzed by using a mask. Generally, MAC addresses are assigned to a specific manufacture with a prefix. Therefore, if the user wanted to filter on a specific CM manufacture, a prefix and MAC could be entered as: 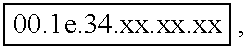
where xx represents the CM MAC address mask location.
Worst Case MER: The worst case MER for any given device will be displayed along with its associated MAC address and SID. The display will hold the worst case MER until an MER of worse magnitude is captured. Once this new worst MER is found, it is displayed until such a time where either three consecutive better MER's are measured for that specific MAC address, or a worse MER is detected. All collected MER data is also archived to hard drive for post analysis by the user.
MER Graphical Display: A bar type indicator is presented in addition to the numerical display for US MER. For example, in the case of CMTS, the bar may include three critical thresholds as indicated as follows:
Red: MER<13 dB (to low to support effective communication)
Yellow: 13≦MER<21 dB (supports QPSK only)
Green: MER≧21 dB (supports QPSK or 16-QAM)
   MER Resolution: MER resolution has three significant digits, as in xx.0 dB, with the third significant digit having 0.25 dB of hysterisis and displayed as either xx.0 dB or xx.5 dB.
   MER Range: MER typical range is <10 dB to >35 dB. Whereby <10 dB is the worst case MER and >35 dB is the best case MER.

The invention has been described with reference to certain preferred embodiments thereof, it will be understood, however, that modification and variations are possible within the scope of the appended claims. For example, although reference is made to portable PC 40 to perform control and computation functions, any computing device capable of performing those functions may be utilized. Further, it is possible to combine the functions of the DOCSIS MAC processor 36 and the PC 40 into one structural unit. Additionally, the types of devices utilized to interface the signal integrity analyzer 24 to the network may vary from the couplers and filters specifically illustrated. These are only representative examples of some of the types of variations that are possible within the scope of the appended claims.

1. An apparatus for measuring upstream signal quality of cable modem communications in a DOCSIS network, said apparatus comprising:
downstream analysis means for analyzing a downstream communication channel of the DOCSIS network and generating a relational database containing MAC addresses and corresponding SID addresses associated with specific cable modems provided in the DOCSIS network;
upstream analysis means for analyzing an upstream communication channel to identify upstream CM signal corresponding to a specific cable modem based on timing information derived in part from the relational database.

2. An apparatus as claimed in claim 1, wherein the downstream analysis means down-converts and demodulates an RF modulated downstream DOCSIS channel, analyzes range-response frames originating from a CMTS provided in the DOCSIS network, and correlates unique cable modem MAC addresses to CMTS assigned unique SID addresses to generate the relational database.

3. An apparatus as claimed in claim 2, wherein the downstream analysis means includes means for examining downstream MAP messages originating from the CMTS and determines timing information corresponding to a respective CM based on information contained in the MAP messages and the relational database.

4. An apparatus as claimed in claim 1, wherein the upstream analysis means includes down-converts and demodulates a specific upstream CM signal and calculates an Modulation Error Ratio.

5. An apparatus for measuring upstream signal quality of cable modem communications in a DOCSIS network, said apparatus comprising:
control means for entering at least one of a selected MAC address and a selected SID address; and
upstream analysis means for analyzing CM burst packets on an upstream channel of the DOCSIS network, wherein the upstream analysis means analyzes only selected CM burst packets having a MAC address or SID address that matches the selected MAC address or selected SID addresses and rejects all packets not matching the MAC or SID criteria.

6. An apparatus as claimed in claim 5, further comprising means for analyzing the selected CM burst packets to determine an Modulation Error Ratio.

7. A method of measuring upstream signal quality of cable modem communications in a DOCSIS network comprising:
analyzing a downstream communication channel of the DOCSIS network;
generating a relational database containing MAC addresses and corresponding SID addresses associated with specific cable modems provided in the DOCSIS network;
analyzing an upstream communication channel to identify upstream CM signal corresponding to a specific cable modem based on timing information derived at least in part from the relational database.

8. A method as claimed in claim 7, wherein the analysis of the downstream communication channel includes down-converting and demodulating an RF modulated downstream DOCSIS channel, analyzing range-response frames originating from a CMTS provided in the DOCSIS network, and correlating unique cable modem MAC addresses to CMTS assigned unique SID addresses to generate the relational database.

9. An apparatus as claimed in claim 8, wherein the analysis of the downstream communication channel further includes examining downstream MAP messages originating from the CMTS and determining timing information corresponding to a respective CM based on information contained in the MAP messages and the relational database.

10. An apparatus as claimed in claim 7, wherein the analysis of the upstream communication channel includes down-converting and demodulating a specific upstream CM signal and calculating an Modulation Error Ratio.

11. A method for measuring upstream signal quality of cable modem communications in a DOCSIS network, said apparatus comprising:
entering at least one of a selected MAC address and a selected SID address; and
analyzing CM burst packets on an upstream channel of the DOCSIS network, wherein the analysis is performed only on selected CM burst packets having a MAC address or SID address that matches the selected MAC address or selected SID address.

12. A method as claimed in claim 11 further comprising analyzing the selected CM burst packets to determine an Modulation Error Ratio.

13. An apparatus for measuring signal quality of cable modem communications in a DOCSIS network, said apparatus comprising:
a downstream (DS) RF input port, an upstream (US) RF input port, and a combined DS/US RF input port;
a filter device coupled to the DS/US RF input port, wherein the filter device separates a combined DS/US RF signal applied to the DS/US RF input port into a filtered DS signal and a filtered UP signal;
a coupling device coupled to receive a DS signal applied to the DS RF input port, an US signal applied to the US RF input port and the filtered DS and US signals from the filter device;
a DS tuner & demodulator and an US tuner & demodulator coupled to the coupling device means;
a media access control (MAC) processor coupled to the DS tuner & demodulator and the US tuner & demodulator; and
a control processor coupled to the MAC processor.
